(19) United States
(12) Patent Application Publication
(10) Pub. No.: US 2012/0251994 A1
(43) Pub. Date: Oct. 4, 2012

(54) SYSTEM AND METHOD FOR DIGITAL FLASHCARD USE BY MULTIPLE INTERNET COMMUNITIES

(75) Inventor: Christopher Don Gray, Cumberland, RI (US)

(73) Assignee: Cogneti, LLC, Nashua, NH (US)

(21) Appl. No.: 13/435,375

(22) Filed: Mar. 30, 2012

Related U.S. Application Data
(60) Provisional application No. 61/470,080, filed on Mar. 31, 2011.

(51) Int. Cl. G09B 7/00

(52) U.S. Cl. 434/362

(57) ABSTRACT

A system and method for an internet community to create and share flashcard decks related to one or more topics is disclosed. An author is responsible for creating flashcard decks while a group lead is responsible for managing access to the decks to a select group of users. Group members use the flashcard decks to learn the content material. An authoring application is used by the authors to create the flashcard decks through the assembly of one or more of rich text, image, audio, and/or video elements. A group management application is used by the group lead for the purpose of creating user groups and managing their access to selected decks as well as various modes of play. A flashcard player is available for web, personal computer, smart phone, and/or tablet use by the group members/users.

### CROSS-REFERENCE TO RELATED APPLICATIONS

This application claims priority from U.S. Provisional Patent Application No. 61/470,080, titled “System and Method for Secure Flashcard Use by Multiple Internet Communities” filed on Mar. 31, 2011 and incorporated fully herein by reference.

### TECHNICAL FIELD

The present invention relates to e-Learning and more particularly, relates to computer-based recall performance training and learning management systems.

### BACKGROUND INFORMATION

The use of printed flashcards as memorization and learning tools is common and well-known in the learning community. Historically, flashcards have been written as a “deck” of paper or cardboard cards made from paper or cardstock. On one side of the card is a question or prompt, and on the other side is the answer. A number of internet sites or computer programs offer electronic versions of flashcards on various subjects. These electronic flashcards work in essentially the same way as paper flashcards and offer essentially the same benefit, albeit that the digital form factor allows easy internet access.

Accordingly, a need exists for flashcards to be enabled with the much greater functionality and benefit expected from modern internet communities. For example, Internet communities should be capable of independently authoring one or more internet-based flashcard decks. Individual groups should be able to share the play of the flashcard decks. The flashcard play should be presented according to the highest and best principles of cognition science that indicates that group and individual scoring, competition, and group chat will all improve the motivation and performance of the participants. Flashcard access must be both secure and private so as to be applicable as necessary for certain government and commercial applications. Flashcard access must be designed in particular for use by mobile-device users who will choose to convert small windows of time (waiting for kids to be free from soccer practice, in an airport security line, or at a doctor's office) into valuable learning time.

### SUMMARY

The present invention features a system and method for an internet community to create and share digitally created and presented flashcard decks. Three roles are supported as part of that community. First is the role of author, responsible for creating flashcard decks. Second is the role of group lead, responsible for managing and providing access to the decks to a select group of users. Third is the role of group member, responsible for the use (play) of flashcard decks and memorization and recall performance of the content material.

The present invention provides three applications in support of the three roles. An authoring application is used by the authors to create the flashcard decks through the assembly of one or more of rich text, image, audio, and/or video resources. A group management application is used by the group lead for the purpose of creating user groups and managing their access to selected decks as well as various modes of play. The third application is a flashcard player that is available for web, personal computer, smart phone, and/or tablet use by the group members/users.

The authoring application is used by the authors to create any number of cards. Each card represents a subject item within an area of study. To each card is added any number of views assembled of rich text, image, video, and audio files. The author may then create any number of categories as part of the deck. Each card can then be categorized by assigning a category value to the card. This allows complex sets of cards to be organized, sorted, and presented in such fashion as to meet group member needs. The author may attach any number of questions to each card, of a variety of types that include multiple-choice, fill-in-the-blank, and true-false formats. The author may also create category-match types of questions that will be presented to the group members as an activity that requires the matching of each card to one of several category values. For each question the author also provides answers that will eventually be used to score user responses. The answers are bound to each question within the flashcard deck, in such a way that they are hidden from the user. When the user provides a response to each question, the response is scored as correct/incorrect using the answers provided by the author. An intended purpose of card design and assembly is to anticipate the sampling of questions for presentation to the user, in such fashion as to ensure that neither the order nor format of the questions can indicate, or allow the user to pre-cognate, the correct answer. The assembly of questions to each card should anticipate that an eventual sampled set of questions and answers appear to the group members as unpredictable and of a non-repetitive nature.

The group management application is used by group leads to create groups of users and manage their play and access. The present invention allows the selected group members to play the deck in two modes. A browse mode allows the group members to freely access the cards within the deck or decks chosen by the group lead. In browse mode, the group members have access to view and study any of the cards within the deck. The second mode available to the group members is the test mode. In test mode, the group members are presented with a fixed set of test questions (a test set) that have been selectively sampled (selected) from the deck by an automated process. In test mode, one or more test sets of sampled questions shall be presented to each group member only during a fixed length of time called the group session. When one session ends, a new session begins and new sets of questions are presented to group members.

The question sets are identical for each member of the group during any given session. That is, all group members are presented the same set of questions. Of course, the responses and scoring are unique to each member. If a group member asks for a second set of questions, a chance to further be tested and to learn, then the new set of questions is also presented to any other requesting group members also asking for another, second test set. The test sets are selective samples of quantities of questions created as part of the deck. The business objective is to create and present the first set of questions for all group members—so they can compare scores. If a second test set is requested by one group member, the same “second” (and subsequent) test set will also be presented to other requesting group members (again, so the test scores can be meaningfully compared). Likewise, for third, fourth, etc. test sets.

During each session, such presentation allows the recall performance of the group members to be measured and scored. This is done by comparing the user response to each question against the answers provided by the author, but withheld from user view until the scoring is complete. The scored questions, along with the user responses, are then available to the members of the group for report and comparison. The group management application presents the means by which these two modes of play are managed by the group lead.

The flashcard player application is available for use on common internet device platforms, which include web browsers, personal computers, smart phones, or tablets. The flashcard player enforces user authentication and security protocols to provide access to the flashcard decks, according to the managed configuration of the group to which an internet user may belong. The flashcard player supports two modes of access to the deck. The first is the browse mode, in which the group member may view and study any card of the deck. The second is the test mode, in which the group member is presented a fixed set of test questions (the test set) that have been selectively sampled from the deck. In test mode, the recall performance of the member is tested, with scored questions and corrected answers made available for report and comparison within the group. This report information is made available not only to the group lead and the individual member taking the test but to other members of the group as well if the group lead has so configured test reporting. The reporting of individual scoring information is configurable and may be turned off by the group lead.

In being enabled for use by internet communities, the functionality of flashcard decks must also address the issues of privacy and mobility. The privacy of individual names, activities, scores, and comments must be protected to be accessible by just the user or users involved. The flashcard decks must be designed and implemented for best transmission over wireless connections, and use within the storage footprints of mobile devices.

Flashcard decks must also support the collaborative aspects of modern internet communities. The basic purpose of learning and memorization of the information contained on any given flashcard decks should be enhanced with the option to add sticky notes or mnemonic devices that can be used privately or shared with others within the group. A mnemonic, or mnemonic device, is a learning technique that aids memory. Common mnemonics are often verbal, something such as a very short poem or a special word used to help a person remember something, particularly lists. Mnemonics rely on associations between easy-to-remember constructs which can be related back to the data that is to be remembered. This is based on the principle that the human mind much more easily remembers spatial, personal, surprising, sexual or humorous or otherwise meaningful information as compared to arbitrary sequences. The power of such mnemonics in aiding memorization is commonly recognized and should be part of flashcard use by internet communities.

As the flashcard decks are digital and viewable on many different digital platforms, the digital flashcard decks are, as well known in the art, customizable in many different manners including but not limited to display size, color, orientation (portrait or landscape) specific features, presentation on the user's screen, user selector buttons and/or control mechanisms, order of presentation, control bar/button presentation, text color, rendering rules, header presentation and the like, all without departing from the scope of the presentation invention.

### BRIEF DESCRIPTION OF THE DRAWINGS

These and other features and advantages of the present invention will be better understood by reading the following detailed description, taken together with the drawings wherein:

FIG. 1 is a system block diagram showing secure flashcard use by multiple internet communities;

FIG. 2 is of the flashcard schema showing the assembly of cards, categories, and activities;

FIG. 3 is the generation process for creating a test set;

FIG. 4 shows organization of a deck to support selection of a test set;

FIG. 5 is an example of a deck organized to support selection of a test set;

FIG. 6 shows session configuration as part of group management;

FIG. 7 is a method for sequential presentation of a flashcard deck according to category;

FIG. 8 shows the sequential selection of card questions that make up a test set;

FIG. 9 illustrates a method of securing private information for individual session participants;

FIG. 10 depicts a single flashcard with multiple views;

FIG. 11 shows how a flashcard deck may be managed and optimized for use with mobile devices;

FIG. 12 illustrates how resource depth levels support the business needs of mobile users; and

FIG. 13 presents the method for adding mnemonic contributions.

### DETAILED DESCRIPTION OF THE PREFERRED EMBODIMENTS

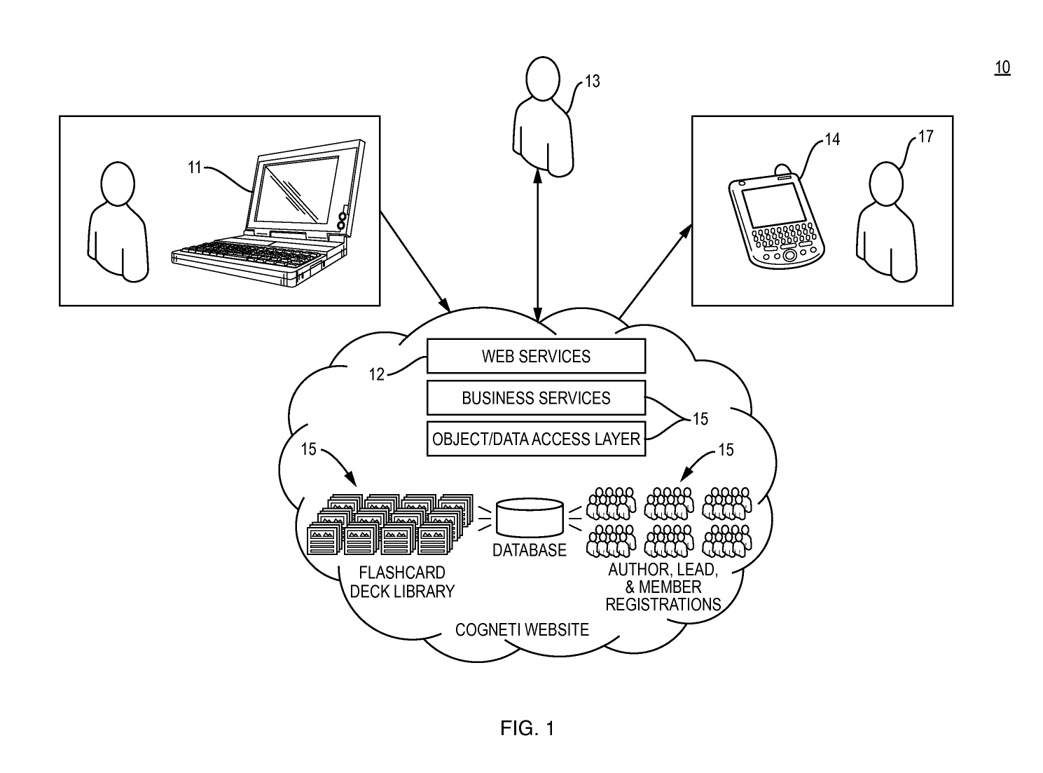

The system 10 of FIG. 1 according to the present invention provides secure flashcard use by multiple internet communities. The system 10 is designed as a repetitive learning experience that connects multiple users and motivates the users with the shared connection or interest of wanting to learn about the subject matter of the flashcard deck and utilizing the social construct of playing against or competing against other learners/players as a motivational tool.

The system includes one or more components loaded on a personal computer or other browser enabled processing device {11} of an author of a flashcard deck. For purposes of describing the present invention, the term flashcard deck will be used to define a collection of digital displayable cards or elements which relate to a common scheme or topic. For example, there may be a “flashcard deck” relating to evergreen trees found in the northeast. This flashcard deck would contain several “cards”, each of which is a digital representation of a collection of selected data (including but not limited to pictures, text, audio or video as determined by the card author) relating to one of the many types of evergreen trees found in the northeast.

The system {10} also includes a web server {12} that hosts web pages that allow for group leaders {13} to select flashcard decks for group study and to create groups of users. A group leader is typically a group member who is responsible for the group creation and management, to include which flashcard decks are played; which users are invited to become group members; and the configuration of privacy and group play settings. The system also includes flashcard player applications {14} that run on various electronic devices including, but not limited to, smartphones, laptops, and tablet devices (such as an IPad™).

The present invention also includes web service and other software service layers {15} that facilitate communications and the management of flashcard deck libraries, groups, and author, lead, and member registration, all as will be explained in greater detail below.

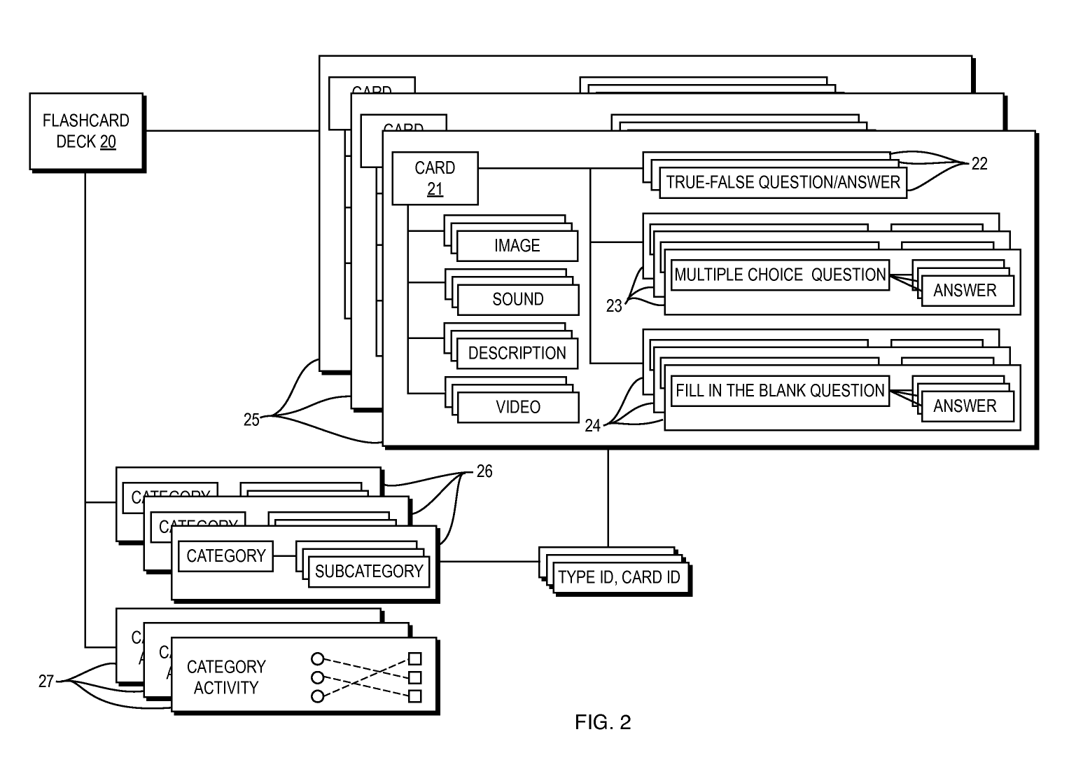

The flashcard deck assembly {20} of FIG. 2 shows that flashcard decks {25} are composed of one or more cards {21}, one or more card categories {26}, and one or more activities {27}. An example of a card category includes: countries of the World. This card category may have more than 200 cards representing different nations, which may further include a continent category, an official language category, and a population category; while examples of activities include: A deck of Countries of the World that could have a scored activity where each country card has to be matched to a continent, or each country card is matched to one of its official languages.

Cards {21} may be made up of images, sounds, text descriptions, and/or videos. One feature of the present invention is that each card 21 may include multi-dimensional or different views. For example, a card 21 for a tree may include a view of the tree in the summer, in the fall, a close-up of the tree leaf, a close-up of the bark of the tree, etc. Thus, one card may provide multiple views relating to that tree thereby providing a very rich description and learning experience for the user. The author of the cards is always able to add additional views and information even after the flashcard deck has been “published”. In addition to image views, a card may include a sound (helpful if the card is used to teach identifying song birds for example) textual description as well as video.

For “teaching” purposes, cards may contain three types of questions namely True/False {22}, Multiple Choice {23}, and Fill in the Blank {24} questions. Any number of questions (of different types—i.e. 22, 23, 24) may be attached to any card {21}, and any number of cards may be attached to any deck {25}. The categories {26} are made part of the deck to facilitate the creation of tests sets, the orderly presentation of deck information to group members, and to create category-based learning activities.

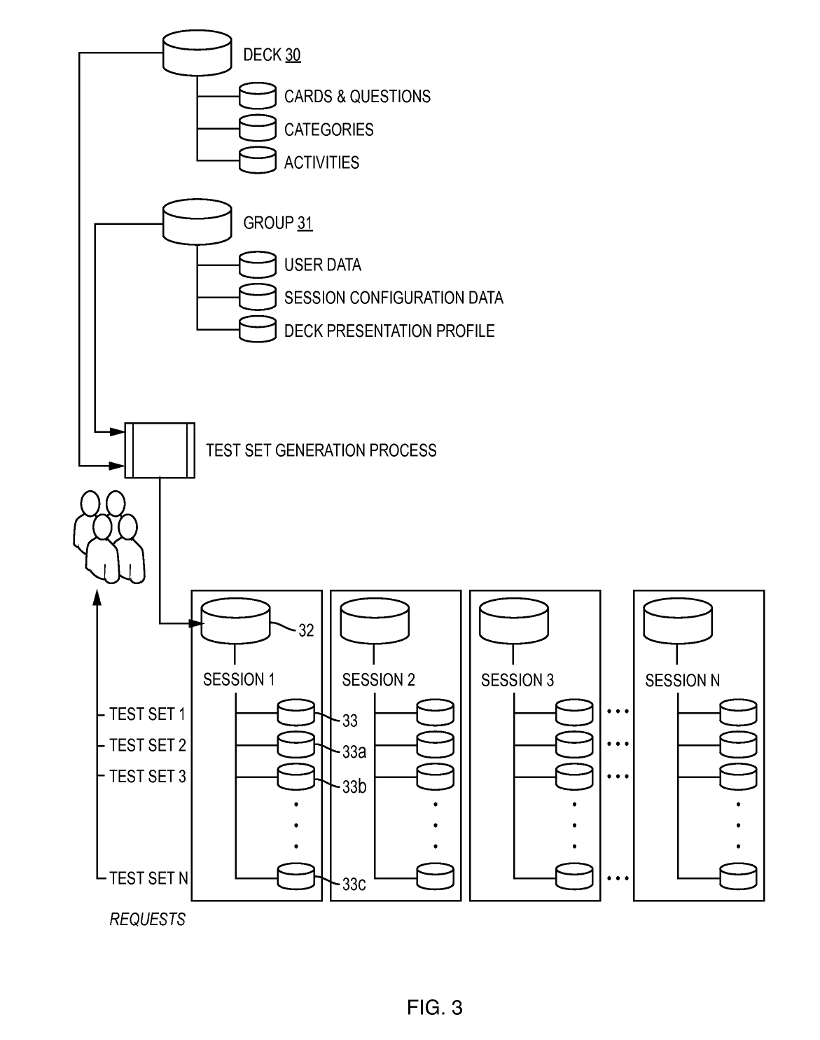

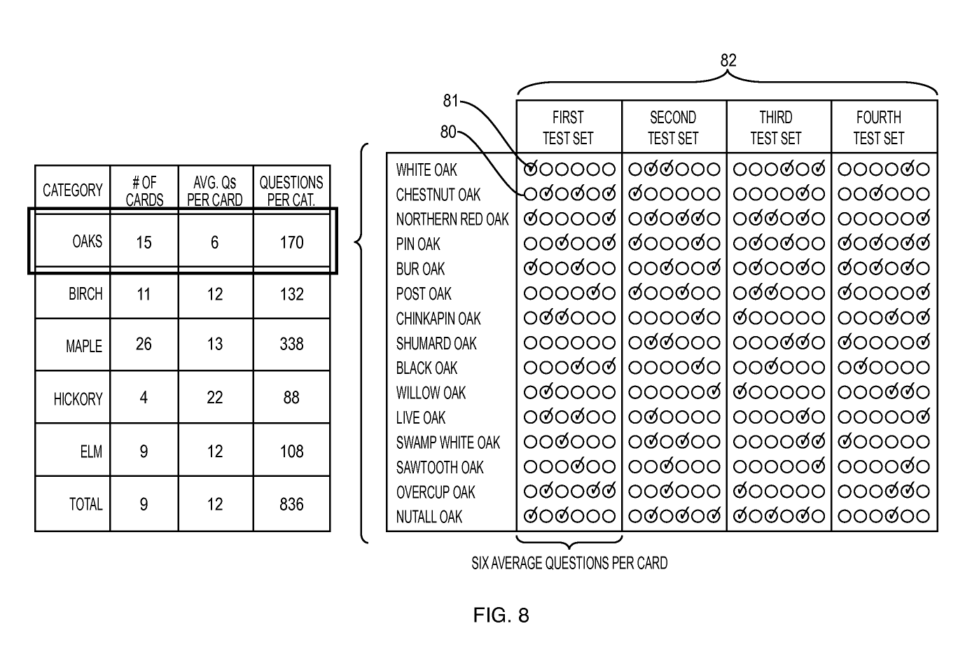

The deck and group schema of FIG. 3 is designed to facilitate the test set generation process. The test set is created by randomly selecting a number of questions from all of the cards of a deck or from just the cards matched to a specific category/subcategory. The exact number of cards to be selected is part of the deck presentation profile created by the group leader—as part of group creation and the choosing of a deck for group play. A typical number of cards to be selected is twenty five. As part of the creation of the deck presentation profile, the group lead also chooses whether the test set should be selected from one category type or from the entire deck. The test set generation process is also described in detail in connection with FIG. 8.

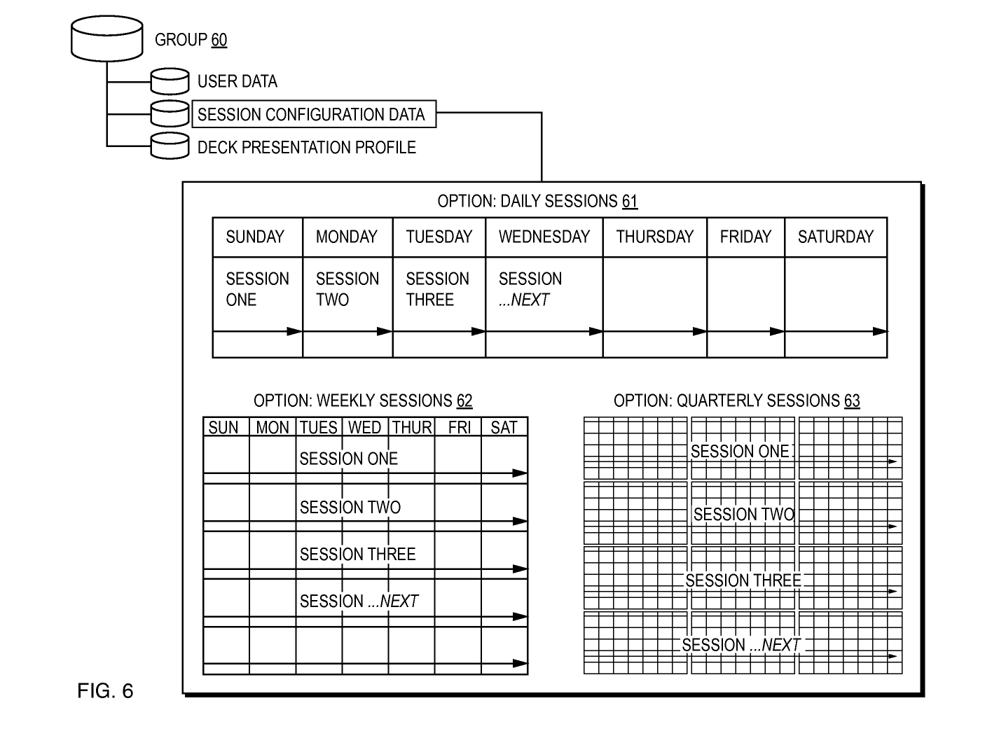

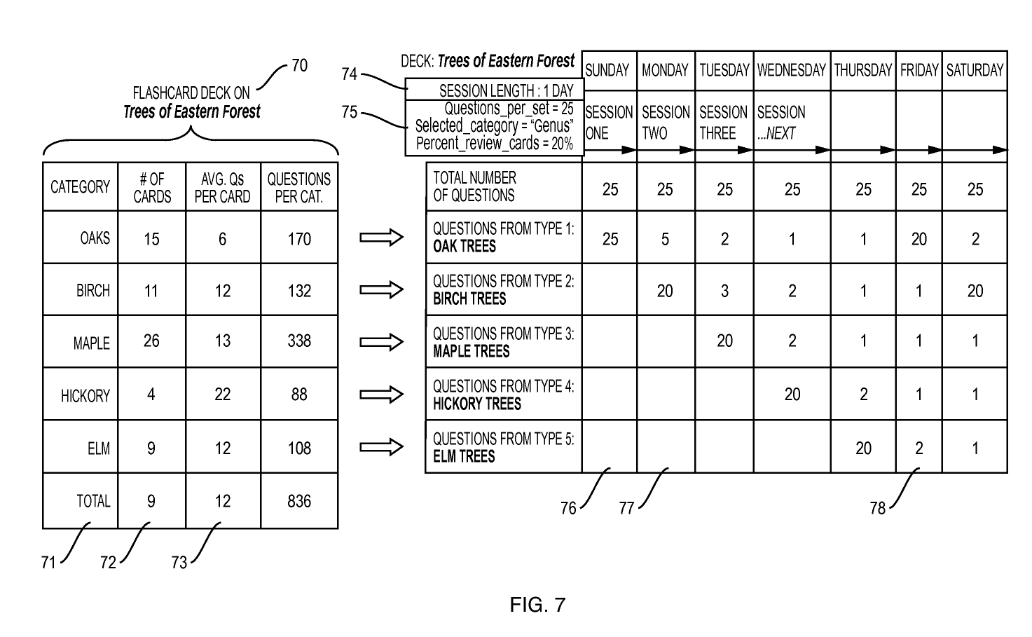

The test set generation process requires that the deck {30} has been previously created with cards & questions, categories, and activities. The process also requires that the groups {31} have been populated with member data, session configuration data as described in FIG. 6, and a deck presentation profile as described in FIG. 7, specifically the call-outs 74 and 75.

The test sets are generated by creating and storing data so that all of the user information for any given session is kept and managed together. This includes creating session data objects {32} (storing the participating user information) at the beginning of each new session, and the new test set objects {33}. Any additional test sets {33a, 33b, 33c, etc.} are created when first requested by any group member, stored together with other session's user information and given in response to other group member requests as well. The questions are randomly and automatically selected from the deck {30} by the system to present unique and non-repeating combinations of questions to the group members.

The total number of questions in each test set {33} is set by the group lead in group configuration data. All test sets within one session object {32} will therefore always have the same total number of questions. Questions shall be sampled from cards that are associated with the primary category that has been targeted for the current session study. A set percentage of questions are sampled from cards that are from the primary category that has been targeted for the current session study as established when setting up the session object {32}. This percentage is part of session configuration data controlled by the group lead. The remainder of questions shall be sampled from categories of cards that were previously studied. Once a question has been used in a test set, it is flagged as used. New test set sampling shall be done to select only unused questions, until all questions have been flagged as used.

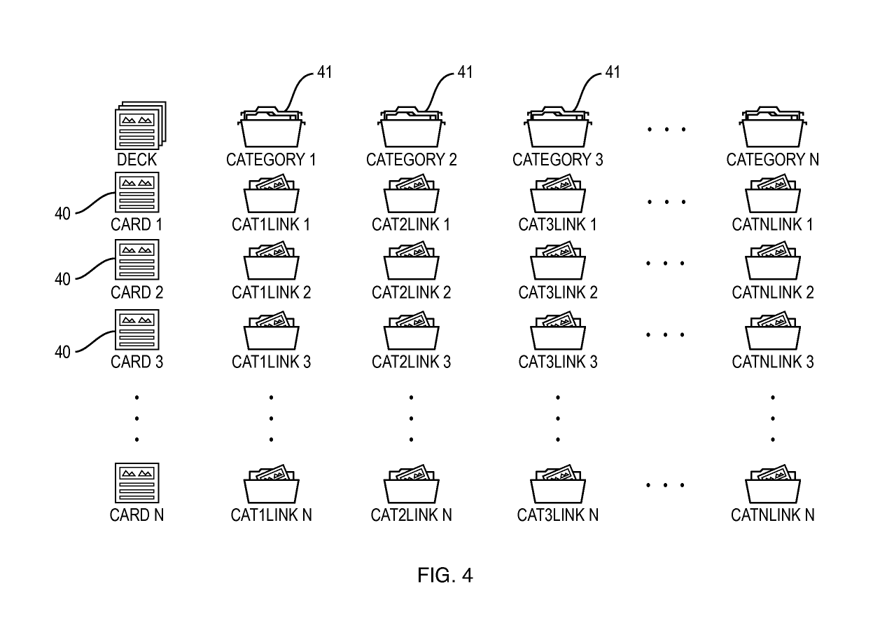

The organization of a deck shown in FIG. 4 supports the selection of a test set. Each card {40} can be associated with one or more categories {41}, which categories can support re-ordering the display of cards, can be used for the creation of matching activities, or can be used to focus session study on just a portion of the cards of the deck.

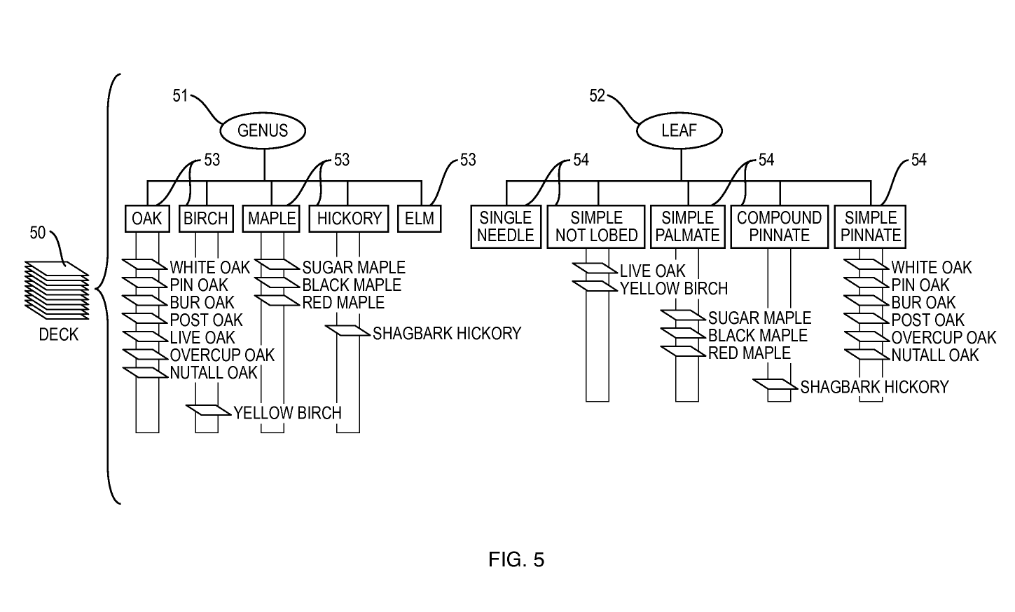

FIG. 5 shows an example of a deck {50} organized to support selection of a test set. The example uses a deck made of twelve cards, each card representing a hardwood tree found in the eastern forest of the United States. The two “categories” of “Genus” {51} and “Leaf” {52} are defined. The category Genus has five subcategories {53} of Oak, Birch, Maple, Hickory, and Elm. The category Leaf has the five subcategories {54} of Single Needle, Simple Not Lobed, Simple Palmate, Compound Pinnate, and Simple Pinnate. Each of the twelve cards {50} is associated with a subcategory {53} of the category {51} Genus, as well as a subcategory {54} of the category {52} Leaf.

FIG. 6 describes session configuration as part of group management {60}. Options for session configuration include, but are not limited to, daily {61}, weekly {62}, and quarterly {63} durations. Sessions can be configured such that a user can complete a session at once or over a span of hours, days, weeks or months. Sessions are configured by the group lead to best meet the needs of group members. Configuring session data is part of group management done by the user in the role of group lead. Session configuration determines when sessions begin and end, and for how long they are repeated. Sessions are expected to align with natural business periods such as days, weeks, months or quarters. The creation of sessions allow the group lead to present the deck in a useful way; such as gradually introducing sets if cards according to the elements of a deck category.

One feature of the present invention is the ability for multiple “groups” to engage in coincident play of a single flashcard deck. For example, Group_1 might be studying and playing Deck 1 according to their preferred configuration and timing while unbeknownst to Group_1, Group_9999 might also be also playing Deck 1 according to their differently preferred configuration and timing.

FIG. 7 illustrates an example of a method of sequentially presenting a series of test sets according to category. Such sequential presentation requires a deck be organized as is illustrated, for example only, by Trees of the Eastern Forest {70}, including a category such as Genus {71} with subcategories of Oaks, Birch, Maple, Hickory, and Elm. Note that there are multiple cards {72} in each category and multiple questions {73} for each card. As part of group management, the session configuration data {74} includes the selection of one day for session duration.

The group management also includes a deck presentation profile {75} containing information that includes settings of twenty five questions per test set, “Genus” as the selected category, and twenty percent as the percentage of test set questions to be used for review. The first test set of the first session {76} is created by selecting all twenty five questions from the cards of the first subcategory “Oaks” from the category “Genus.”

The user group can select as many additional test tests as they may want during the first session. However all test sets in a given session will be sampled according to the same logic, thereby representing the same category and subcategory. At the beginning of the second session {77} a test set is created that will include 20 questions from the second subcategory “Birch” of the category “Genus.” For the second session, twenty percent of the questions will come from subcategories that have been previously reviewed. Consequently five of the twenty-five questions of the test set shall come from the category “Oak” that was in prior review. This same logic continues until all subcategories have been the primary focus of review, at which point the process repeats {78}.

FIG. 8 illustrates the sequential selection of card questions to make up a test set. The test sets are all from a single session, and therefore all come from the same subcategory of “oaks” in this example. In this example, the available questions are represented by circles {80}. The checkmarks {81} indicate a question has been selected as part of a test set. The sequence {82} shows how test sets are created and presented to the user as non-repeating combinations of card questions that also ensures an eventually complete presentation of all available questions. The test set is designed to demonstrate recall learning over time, through repetition. In this example, the quantity of questions in the session deck is set to 25. Each successive test set is comprised of a random selection of questions.

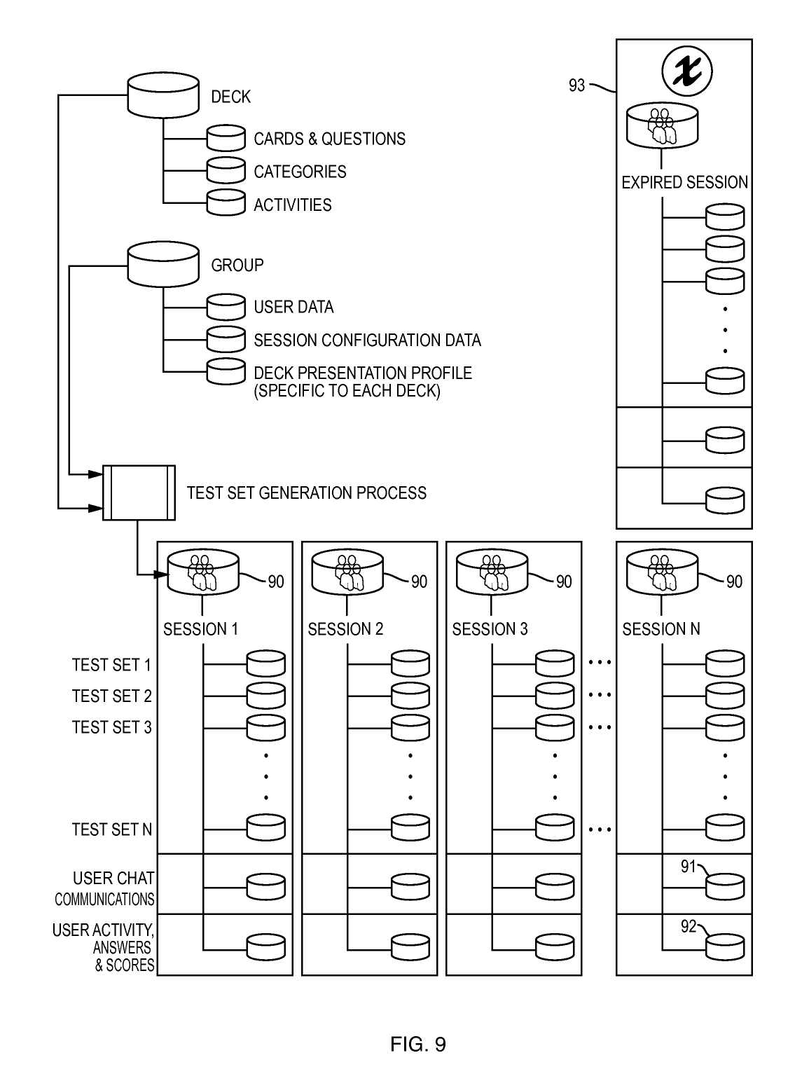

FIG. 9 shows how private information can be utilized and secured for individual session participants. The session objects that are created at the beginning of each session {90} include user IDs that identify the group members that are participating in the session. In some cases, there is certain private user information that may be known to other group participants, such as the sender name of chat communications, member positions on high score lists, or the number of requests made for additional test sets. Group activity and/or individual group member performance results may be shared to further motivate and users. When the group information is shared among users, a social construct is created, whereby each user is made aware of the activity and performance of other users.

To secure the privacy of chat communications, all user chat communications that are generated during the session are stored as child objects {91} of the parent session object {90}. To secure the privacy of user activity, answers, and scores, all such information is stored as child objects {92} of the parent session object {90}. All access to session and child objects are secured to only those authenticated group members with user IDs that match those that are found within the session object. This ensures that new group participants cannot access any information from a session without having been an original participant in that session. When a session is expired, a deletion of the session object {93} ensures that all private information associated with the session is deleted and no longer available for access.

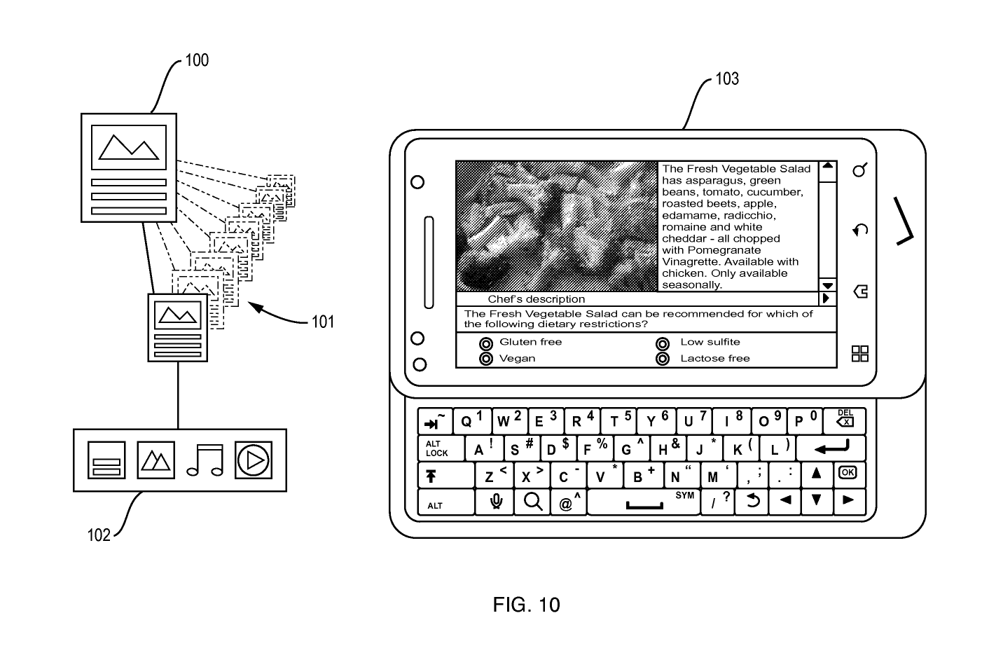

FIG. 10 depicts a single flashcard with multiple views. Each card {100} is made up of a collection of one or more views {101}. The views may be used to describe the card subject from different angles or in different situations. The views are meant to literally provide different views of a card subject. A card on an Eastern Sycamore Tree could show four views from each of the four seasons of the year, for example. Or a Venezuela card from the Countries of the World could have views of agriculture, oil & mineral facilities, and natural features such as Angel Falls and the Orinoco river. Each view {101} is made up of one or more of four elements {102}. These elements {102} include rich text, image, audio, and video. When the card is shown on a mobile device player {103}, the user may choose to see repeated but different views of the card. Each new view may then show a different aspect of the card subject. For example, a Yellow Perch (Perca flavescens) card from a Gamefish of North America deck may include views of the male in spawning colors, the female laying egg strands, schooling behavior, or the hatching frye. The deck author anticipates this by building cards with multiple views.

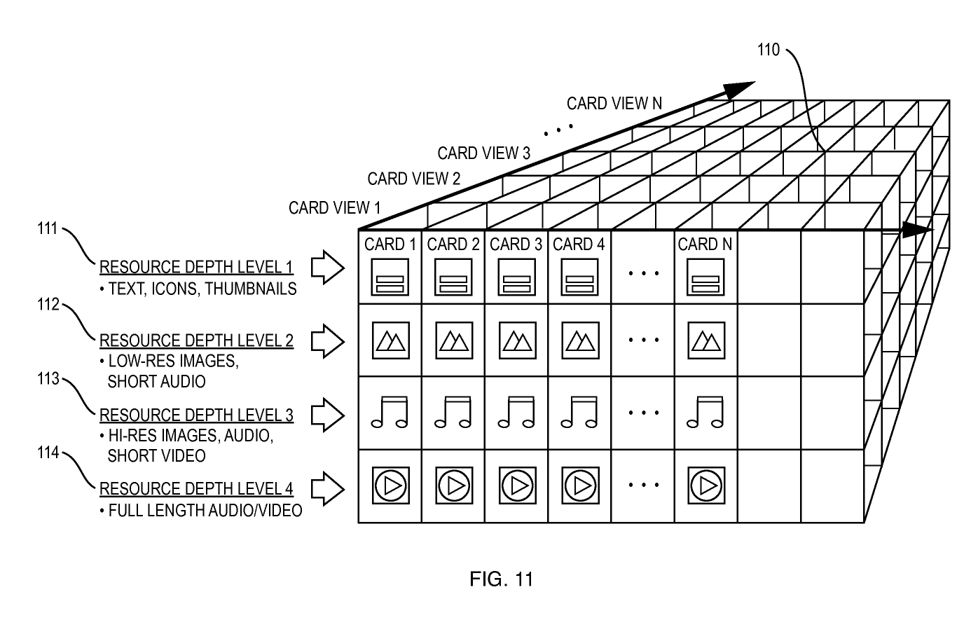

FIG. 11 describes the Resource Depth Level (RDL) management that optimizes the flashcard decks for use with mobile devices. The RDL management has the purpose of best matching the needs of the mobile device user to the type of mobile device and the connection (wireless or WiFi) that they are using. Each RDL contains a complete set of cards and views {110}. RDL 1 {111} for example, contains sparse but complete descriptions of each view, such as text, icons, and thumbnails. RDL 2 {112} contains all resources of RDL 1, and may also include more resource-intensive descriptors such as low-resolution images, and small(er) audio files. RDL 3 {113} contains all resources of RDL 2, and may also include hi-resolution images, audio, and small video files. RDL 4 {114} contains all resources, including full length audio & video.

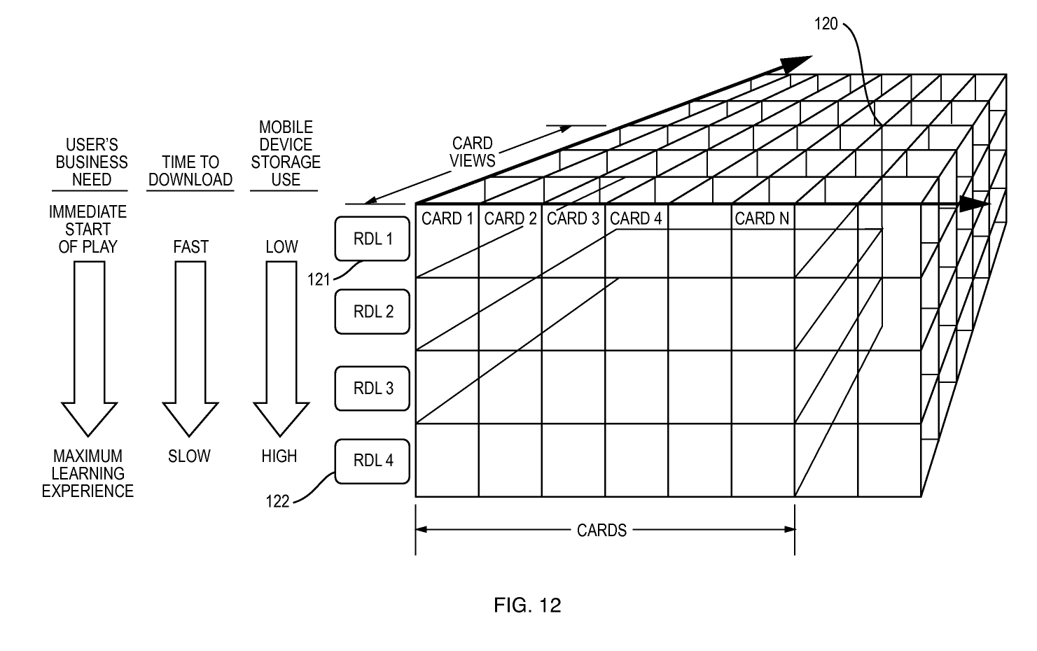

FIG. 12 shows how Resource Depth Levels support the needs of mobile users. When a deck or test set is requested by the user, it will be comprised of a number of cards and card views (120}. The use of Resource Depth Level (RDL) management allows the mobile user's needs and situation (type of mobile device and connection type) to be met efficiently and flexibly, whether they are using a slow or fast wireless connection (or WiFi), or a mobile device with a little or a lot of storage. The RDL level to be used by a given user is either automatically determined by detecting the type of device and connection type of the device, or may be selected manually by the user. For example, one option would allow a user to go into “airplane mode” by purposely downloading a certain level of resources before going into a disconnected state. The sparser description of a deck described by RDL 1 (121} allows users to quickly start play, as may be needed when a mobile user converts small windows of opportunity into valuable learning time. The full & rich description of the deck described by RDL 4 (122} allows users to have a more immersive learning experience.

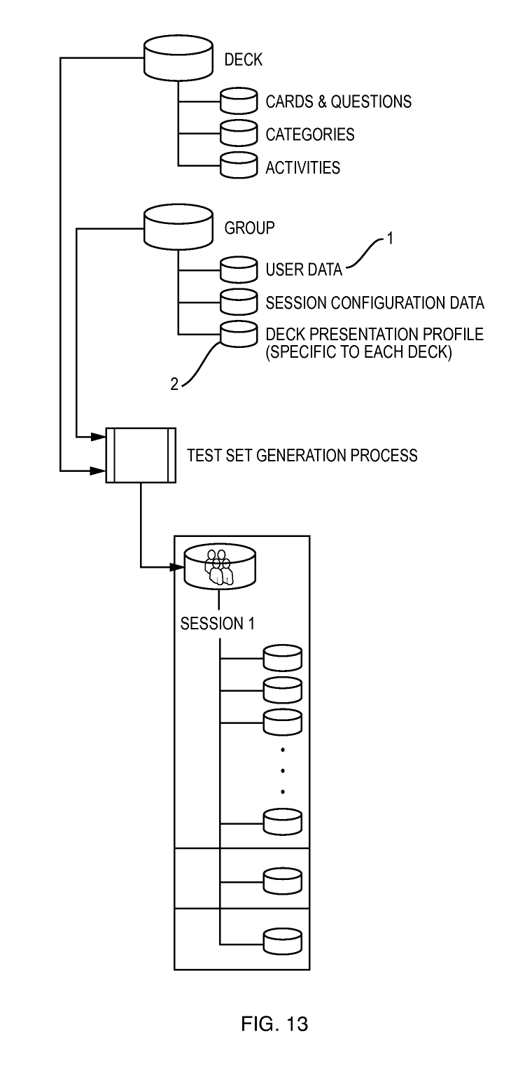

FIG. 13 describes how mnemonics can be added to a card by a member of the group. Proposed is a system of having group members contribute useful mnemonics to the flashcard decks. There could be three settings for this function. First, is no mnemonic use. Second is personal mnemonic use, where the mnemonic is created by the end user with the mobile player, and added to the user data table {1} at the group level, and associated with the deck and card. The mnemonic is subsequently available to only the user that created the mnemonic. If the user is deleted from the group, all associated mnemonics are also deleted.

The third setting is for the addition of mnemonics for use by the entire group, where the mnemonic is created by one end user and then presented to the group lead for acceptance. When the group lead approves the mnemonic, it is then added to the deck presentation profile {2} within the group object. The mnemonic is subsequently available as an attribute of the card to all group members when the card is presented. When the deck object is deleted from the group by the group lead, all attached mnemonic information is also deleted. The group lead can also choose to forward a mnemonic to the author. The author may then add the mnemonic to the deck during the next revision.

Accordingly, the present invention provides a novel system and method for an internet community to create and share flashcard decks. An author is responsible for creating flashcard decks while a group lead is responsible for managing access to the decks to a select group of users. Group members use the flashcard decks to learn the content material and accelerate their development of recall performance. A flashcard player is available for web, personal computer, smart phone, and/or tablet use by the group members/users in order to facilitate the member's use and learning of the material provided in the flashcard deck.

Modifications and substitutions by one of ordinary skill in the art are considered to be within the scope of the present invention, which is not to be limited except by the allowed claims and their legal equivalents.

The invention claimed is:

1. A computerized method of using an automated computer program to create a collection of user viewable flashcards, said computerized method comprising the acts of:
assembling a plurality of cards, each of said plurality of cards including one or more of rich text, one or more images, one or more audio files and one or more video files relating to a common category of information;
assembling a quantity of questions, in multiple question format types, corresponding and relating to said plurality of cards, said quantity of questions configured so as to enable the creation of a series of subset questions and answers, wherein said series of subset questions are configured and arranged as test sets, said test sets configured for developing and testing the recall performance of group member participants concerning said common category of information; and
said computerized method randomly presenting to a user at least some of said plurality of cards and a selection of corresponding questions and answers from the plurality of presented cards.

2. The method of claim 1, further including sampling sets of flashcard questions in such a way as to present all questions for a given flashcard, before any single question for that flashcard is repeated a second time.

3. The method of claim 1, wherein said automated computer program is configured to manage the incremental progression of flashcard study through a series of categories and subcategories and coordinated with a sequence of time periods.

4. The method of claim 1, wherein said automated computer program is configured to secure private information for access only by said group member participants and wherein said access is based on time/session participation, to provide that all user identities, flashcard viewing activity, performance scores, and chat/messaging communications for a session be private and securely available only to said group member participants.

5. The method of claim 1 wherein said automated computer program is configured to allow a first and at least a second group to simultaneously access a first flashcard.

6. The method of claim 1, wherein said automated computer program is configured to optimize the transmission of flashcard decks to mobile and other network devices using resource depth levels, wherein said flashcard deck is capable of complete transmission of all cards and views using a plurality of different levels of resource complexity and size.

7. The method of claim 1, wherein said automated computer program is configured to allow mnemonic devices to be added to the plurality of flashcards and to be used by said group member participants, wherein said mnemonic devices are available to either a single contributing user or optionally to all group member participants.

8. A method of providing a group learning system, said group learning system configured to operate on a computer system, wherein said method comprises:
creating, by an author, a deck of digital flashcards as part of an internet based computer program configured to operate on a computer processing device, wherein said deck of digital flashcards is composed of one or more digital cards, each said one or more digital cards arranged into one or more categories, subcategories and one or more activities, wherein said one or more categories are configured to facilitate creation of one or more test sets through creation of a session data object, said test sets created by randomly selecting a number of questions from all of said digital flashcards matched to a specific subcategory;
creating by a group leader session configuration data, wherein said session configuration data includes an exact number of said digital flashcards to be selected as part of each said test set and wherein said session configuration data is associated with said session data object; and
creating a group of one or more end users, wherein said group of one or more end users is populated with user profile member data and said session configuration data and wherein said group is associated with said session data object.

9. The system of claim 8, wherein said one or more digital flashcards includes at least one of the following: images, sounds, text descriptions, and/or videos.

10. The system of claim 8, wherein said digital flashcards contain at least one of the following types of questions: true/false, multiple choice, or fill in the blank questions.

11. The system of claim 8, wherein creation of said session configuration data includes selecting said test set from one of said one or more categories or from said entire deck of one or more cards.

12. The system of claim 8, wherein said test sets are generated by creating and storing data so that all user information for any given session is maintained with said session data object.

13. The system of claim 8, wherein a session data object includes a first test set object, followed by additional test set objects such that each test set created by said group lead or requested by said one or more users in said group automatically generates a test set object.

14. The system of claim 8, wherein test set results from each of said one or more users are stored as part of said user profile member data.

15. The system of claim 8, wherein said session configuration data includes a timing profile set by said group lead of one of the following: daily, weekly, monthly or quarterly.

16. A method of sequentially presenting a series of test sets for a group learning system, said group learning system configured to operate on a computer system, said method comprising the following acts:
creating a digital flashcard deck for at least one category of information, said at least one category including at least a first subcategory and a second subcategory, wherein said first subcategory and said second subcategory each include a plurality of digital flashcard deck cards, each of said plurality of flashcard deck cards including a plurality of questions;
generating a plurality of test sets for a group of users, wherein a session data object on an automated computer system maintains all of said plurality of test sets;
generating session configuration data by an automated computer system, said session configuration data including selection of session duration and formation of a deck presentation profile, said deck presentation profile including a predetermined number of questions per test set, categories to be used and a percentage of test set questions to be used for review;
initiating a first session on said automated computer system, wherein said first session features a first test set; and
initiating a second session on said automated computer system, wherein said second session features a second test set and wherein a percentage of questions in said second test set will come from said first test set.

17. The method of claim 16, wherein said first session and said second session are associated with said session data object, and wherein said session data object includes a user ID for each group member participating in said first and second sessions.

18. The method of claim 16, wherein said session data object includes user information that is known to all other group participants.

19. The method of claim 17, wherein all user chat communications, user activity, answers, and scores generated during said first and second session are stored as child objects of said session data object and wherein access to said session data objects and said child objects are available to only authenticated group members with user IDs that match those that are found within said session object.

20. The method of claim 16, wherein each card includes a plurality of views, wherein each of said plurality of views is made up of one or more elements selected from the group consisting of rich text, image, audio, and video.

21. The method of claim 16, said method further comprises:
providing two or more resource depth levels, each of said two or more resource depth levels containing a complete set of cards and views; wherein resource depth level management is configured to automatically determine a type of mobile device being used by a user and a type of connection used by said mobile device and determining an optimal resource depth level for said user based on said user's mobile device and said type of connection.

22. The method of claim 16, wherein said system allows a user to create a personal mnemonic and add said personal mnemonic to a user data table associated with said deck or said card, such that said personal mnemonic is available to only said user that created the personal mnemonic.

23. The method of claim 16, further comprising the act of: creating a mnemonic by one end user, said mnemonic associated with a particular card;
presenting said mnemonic to a group lead for acceptance;
approving said mnemonic by said group lead, wherein said approving act adds said mnemonic to said deck presentation profile within said session data object and makes said mnemonic available as an attribute of said particular card to all group members when said particular card is presented to any user associated with said group of users.
